(19) United States
(12) Patent Application Publication
(10) Pub. No.: US 2025/0364886 A1
(43) Pub. Date: Nov. 27, 2025

(54) POWER SUPPLY CONTROLLER AND SWITCHING POWER SUPPLY

(71) Applicant: ROHM CO., LTD., Kyoto (JP)

(72) Inventor: Shun FUKUSHIMA, Kyoto (JP)

(21) Appl. No.: 19/208,767

(22) Filed: May 15, 2025

(30) Foreign Application Priority Data
May 23, 2024 (JP) 2024-083950

(51) Int. Cl. H02M 1/00; H02M 1/08; H02M 3/158

(52) U.S. Cl. CPC H02M 1/0025; H02M 1/0009; H02M 1/08; H02M 3/158

(57) ABSTRACT

A power supply controller controlling an output circuit of a switching power supply that generates an output voltage from an input voltage includes: an error amplifier generating an error signal according to an error between a feedback voltage corresponding to the output voltage and a predetermined reference voltage; a current sensor generating a current detection signal according to a coil current flowing the output circuit; a duty signal generation circuit generating a duty signal upon receiving the current detection and error signals; and a drive signal generation circuit generating a drive signal for the output circuit upon receiving the duty signal, wherein the error amplifier is switched, by a mode switching signal, between a first mode of generating the error signal using an integral voltage by integrating a difference value between the reference and feedback voltages, and a second mode of generating the error signal without using the integral voltage.

### CROSS-REFERENCE TO RELATED APPLICATION

The present invention claims priority under 35 U.S.C. § 119 to Japanese Patent Application No. 2024-083950, filed on May 23, 2024, the entire contents of which are incorporated herein by reference.

### TECHNICAL FIELD

The present disclosure relates to a power supply controller and a switching power supply.

### BACKGROUND

In the related art, a switching power supply that generates a desired output voltage from an input voltage by turning an output transistor on and off has been used as power supply means for various applications.

### BRIEF DESCRIPTION OF DRAWINGS

The accompanying drawings, which are incorporated in and constitute a part of the specification, illustrate embodiments of the present disclosure.

FIG. 1 is a diagram showing a switching power supply according to a comparative example.

FIG. 2 is a diagram showing a load response waveform when a load line function is disabled.

FIG. 3 is a diagram showing a load response waveform when the load line function is enabled.

FIG. 4 is a diagram showing an overall configuration of a switching power supply according to the present disclosure.

FIG. 5 is a diagram showing a relationship between an error signal and a coil current.

FIG. 6 is a diagram showing an error amplifier according to a first embodiment.

FIG. 7 is a diagram showing a load response waveform when the error amplifier according to the first embodiment is in a first mode.

FIG. 8 is a diagram showing a load response waveform when the error amplifier according to the first embodiment is in a second mode.

FIG. 9 is a diagram showing an error amplifier according to a second embodiment.

FIG. 10 is a diagram showing a load response waveform when the error amplifier according to the second embodiment is in a first mode.

FIG. 11 is a diagram showing a load response waveform when the error amplifier according to the second embodiment is in a second mode.

FIG. 12 is a diagram showing a first example of a soft-start function.

FIG. 13 is a diagram showing a second example of the soft-start function.

FIG. 14 is a diagram showing a modification of the switching power supply according to the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### <Switching Power Supply (Comparative Example)>

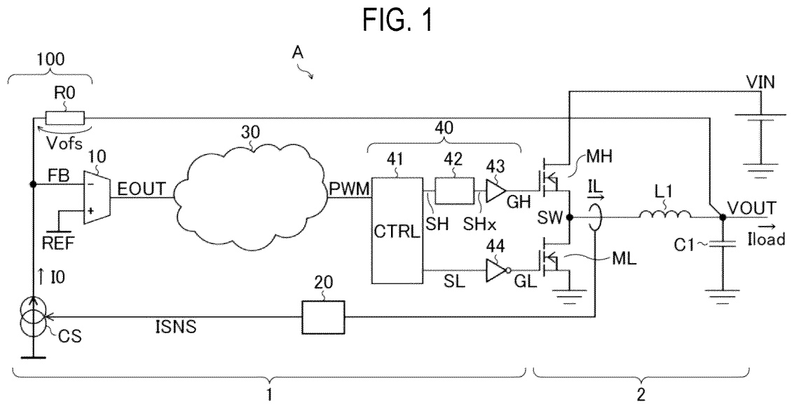

FIG. 1 is a diagram showing a switching power supply A according to a comparative example (=a configuration to be compared with the present disclosure described later). The switching power supply A of this comparative example is a DC/DC converter that generates an output voltage VOUT and a load current Iload from an input voltage VIN and supplies them to a load (not shown). Referring to this figure, the switching power supply A includes a power supply controller 1 and an output circuit 2.

The power supply controller 1 receives feedback inputs of an output voltage VOUT and a coil current IL to control a current mode of the output circuit 2. Referring to the figure, the power supply controller 1 includes an error amplifier 10, a current sensor 20, a duty signal generation circuit 30, a drive signal generation circuit 40, and a load line function circuit 100. The power supply controller 1 may include other components (such as a protection circuit). The power supply controller 1 may be provided as a semiconductor integrated circuit device such as a power supply control IC [integrated circuit] or a PMIC [power management IC].

The error amplifier 10 generates an error signal EOUT according to an error between a feedback voltage FB (=VOUT+Vofs) applied to an inverting input terminal (−) thereof and a reference voltage REF applied to a non-inverting input terminal (+) thereof. The error signal EOUT increases when the feedback voltage FB is lower than the reference voltage REF, and decreases when the feedback voltage FB is higher than the reference voltage REF.

The current sensor 20 generates a current detection signal ISNS according to the coil current IL flowing through the output circuit 2.

The duty signal generation circuit 30 receives the error signal EOUT and generates a duty signal PWM. The duty signal generation circuit 30 may be implemented with a known circuit configuration, and therefore a detailed description thereof is omitted.

The drive signal generation circuit 40 receives the duty signal PWM and generates each of a high-side drive signal GH and a low-side drive signal GL for the output circuit 2. Referring to this figure, the drive signal generation circuit 40 includes a controller 41, a level shifter 42, a buffer 43, and an inverter 44.

The controller 41 receives the duty signal PWM and generates each of a high-side control signal SH and a low-side control signal SL. For example, the controller 41 may set each of the high-side control signal SH and the low-side control signal SL to a high level when the duty signal PWM is at a high level. Further, the controller 41 may set each of the high-side control signal SH and the low-side control signal SL to a low level when the duty signal PWM is at a low level.

The level shifter 42 generates a high-side control signal SHx by level-shifting the high-side control signal SH. The high-side control signal SH may be pulse-driven by a drive voltage of the controller 41. On the other hand, the level-shifted high-side control signal SHx may be pulse-driven by a drive voltage of the buffer 43.

The buffer 43 buffers and amplifies the high-side control signal SHx to generate a high-side drive signal GH. Therefore, the high-side drive signal GH is at a high level when the high-side control signal SHx is at a high level. Further, the high-side drive signal GH is at a low level when the high-side control signal SHx is at a low level.

The inverter 44 inverts a logic level (high level/low level) of the low-side control signal SL to generate a low-side drive signal GL. Therefore, the low-side drive signal GL is at a low level when the low-side control signal SL is at a high level. Further, the low-side drive signal GL is at a high level when the low-side control signal SL is at a low level.

The output circuit 2 steps down the input voltage VIN to generate the output voltage VOUT. Referring to the figure, the output circuit 2 includes transistors MH and ML (e.g., N-channel MOSFETs [metal oxide semiconductor field effect transistors]), a capacitor C1, and a coil L1.

A drain of the transistor MH is connected to a terminal for applying the input voltage VIN. A source and a back gate of the transistor MH are connected to a terminal for applying a switch voltage SW. A gate of the transistor MH is connected to a terminal for applying the high-side drive signal GH. The transistor MH is in an on state when the high-side drive signal GH is at a high level, and is in an off state when the high-side drive signal GH is at a low level. The transistor MH connected in this manner functions as a high-side switch of a half-bridge output terminal, i.e., an output transistor. The transistor MH may be replaced with a P-channel MOSFET.

A drain of the transistor ML is connected to the terminal for applying the switch voltage SW. A source and a back gate of the transistor ML are connected to a reference potential terminal. The reference potential terminal may be, for example, a ground terminal. A gate of the transistor ML is connected to a terminal for applying the low-side drive signal GL. The transistor ML is in an on state when the low-side drive signal GL is at a high level, and in an off state when the low-side drive signal GL is at a low level. The transistor ML connected in this manner functions as a low-side switch of a half-bridge output terminal, i.e., a synchronous rectification transistor.

The transistors MH and ML are complementarily turned on and off in response to the high-side drive signal GH and the low-side drive signal GL. This on/off operation generates a square-wave switch voltage SW. The term “complementarily” should be understood in a broad sense to include not only a case where the on/off states of the transistors MH and ML are completely reversed, but also a case where a simultaneous off period (dead time) of the transistors MH and ML is provided.

The transistors MH and ML may be any of Si devices, SiC devices, and GaN devices. The transistors MH and ML may be replaced with, for example, IGBTs [insulated gate bipolar transistors]. When the power supply controller 1 is provided as a semiconductor integrated circuit device, the transistors MH and ML may be integrated into the power supply controller 1. Alternatively, the transistors MH and ML may be externally attached to the power supply controller 1.

A first end of the coil L1 is connected to the terminal for applying the switch voltage SW. A second end of the coil L1 and a first end of the capacitor C1 are connected to a terminal for applying the output voltage VOUT. A second end of the capacitor C1 is connected to a reference potential terminal. The coil L1 and the capacitor C1 connected in this manner function as an LC filter that rectifies and smoothes the switch voltage SW to generate the output voltage VOUT. When the power supply controller 1 is provided as a semiconductor integrated circuit device, the coil L1 and the capacitor C1 may be externally attached to the power supply controller 1.

An output type of the output circuit 2 is not limited to a step-down type, but may be any of a step-up type, a step-up/step-down type, and an inverting type. A rectification type of the output circuit 2 is not limited to a synchronous rectification type, but may be a diode rectification type using a rectifier diode as the low-side switch of the half-bridge output terminal.

The load line function circuit 100 realizes a function of changing the output voltage VOUT in response to the load current Iload, i.e., a so-called load line function. Referring to this figure, the load line function circuit 100 includes a current source CS and a resistor R0.

The current source CS is connected between a terminal for applying the feedback voltage FB and the reference potential terminal to generate a variable current I0 according to a current detection signal ISNS. The variable current I0 may be a current proportional to an average value of the coil current IL, and further, to the load current Iload (I0 ∝Iload).

The resistor R0 is connected between the terminal for applying the output voltage VOUT and the terminal for applying the feedback voltage FB. An offset voltage Vofs (=I0×R0) according to the variable current I0 is generated across the resistor R0.

As a result, the feedback voltage FB becomes a sum voltage (=VOUT+Vofs) of the output voltage VOUT and the offset voltage Vofs. Therefore, the feedback voltage FB increases as the load current Iload increases.

The power supply controller 1 performs output feedback control so that the feedback voltage FB coincides with the reference voltage REF. Therefore, by implementing the load line function circuit 100, output feedback control is executed such that the output voltage VOUT decreases as the load current Iload increases.

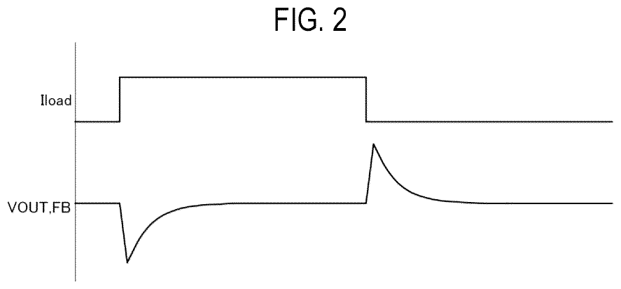

FIG. 2 is a diagram showing a load response waveform when the load line function is disabled, i.e., a load response waveform when the load line function circuit 100 is not implemented in the power supply controller 1. In this figure, the load current Iload and the output voltage VOUT (which may be understood as the feedback voltage FB) are depicted sequentially from the top.

As shown in this figure, when the load line function is disabled, overshoot and undershoot occur in the output voltage VOUT in response to fluctuations in the load current Iload. Therefore, accuracy of the output voltage VOUT deteriorates.

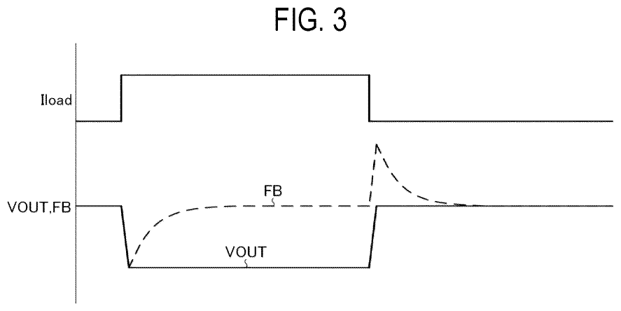

FIG. 3 is a diagram showing a load response waveform when the load line function is enabled, i.e., a load response waveform when the load line function circuit 100 is implemented in the power supply controller 1. In this figure, the load current Iload, the output voltage VOUT (solid line), and the feedback voltage FB (broken line) are depicted sequentially from the top.

As shown in this figure, when the load line function is enabled, as the load current Iload increases, the output voltage VOUT is DC-pulled down by the same amount as an amount of undershoot, making it difficult for the output voltage VOUT to overshoot. A target value VOUT_target of the output voltage VOUT may be set higher by ½ of the amount of undershoot in advance. This setting makes it possible to increase the accuracy of the output voltage VOUT (e.g., from ±6% to ±3%).

### <Consideration Regarding Load Line Function>

A purpose of implementing the load line function circuit 100 in the power supply controller 1 is to equalize the transient overshoot and undershoot of the output voltage VOUT with a DC fluctuation component during load fluctuation. However, with the switching power supply A of this comparative example, it is not necessarily easy to achieve the above purpose.

As a specific problem, the overshoot and undershoot of the output voltage VOUT during the load fluctuation are determined by circuit configurations of the error amplifier 10 and the duty signal generation circuit 30. On the other hand, the DC fluctuation component of the output voltage VOUT during the load fluctuation is determined by a voltage value of the offset voltage Vofs, i.e., a current value of the variable current I0 and a resistance value of the resistor R0. Therefore, it is difficult to set the overshoot and undershoot of the output voltage VOUT and the DC fluctuation component independently during the load fluctuation.

Further, in order to switch between enabled and disabled states of the load line function in the switching power supply A of this comparative example, it is necessary to switch between whether or not to incorporate the load line function circuit 100 into an output feedback system of the power supply controller 1. Therefore, it is necessary to adjust other control circuits forming the output feedback system according to whether the load line function is in the enabled state or the disabled state. For this reason, it is difficult to arbitrarily switch between enabled and disabled states of the load line function while keeping the control circuits other than the load line function circuit 100 common.

In view of the above considerations, a switching power supply A capable of arbitrarily switching the load line function between enabled and disabled states and further capable of arbitrarily adjusting load response characteristics and load line characteristics is disclosed below.

### <Switching Power Supply (Overall Configuration)>

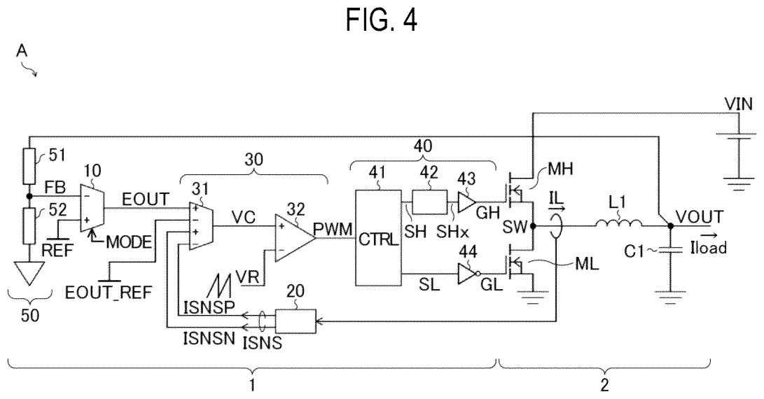

FIG. 4 is a diagram showing an overall configuration of the switching power supply A according to the present disclosure. The switching power supply A according to the present disclosure is based on the comparative example (FIG. 1) described above, but the load line function circuit 100 is omitted and the error amplifier 10 is modified. Further, in this figure, the current sensor 20 is a differential output type, and an internal configuration of the duty signal generation circuit 30 is shown accordingly. The switching power supply A according to the present disclosure further includes an output feedback circuit 50. The above differences are described in detail below.

The current sensor 20 differentially outputs a positive-phase current detection signal ISNSP and a negative-phase current detection signal ISNSN as current detection signals ISNS. For example, the current sensor 20 converts the average value of the coil current IL into a difference voltage (ISNSP−ISNSN) between the positive-phase current detection signal ISNSP and the negative-phase current detection signal ISNSN.

The current sensor 20 may sample the coil current IL during an on-period of the output circuit 2, i.e., at a center of a period during which the transistor MH is turned on and the transistor ML is turned off. Alternatively, the current sensor 20 may sample the coil current IL during an off-period of the output circuit 2, i.e., at a center of a period during which the transistor MH is turned off and the transistor ML is turned on.

When such sampling is performed, output feedback control is executed to maintain the average value of the coil current IL, and hence the load current Iload, constant, in the switching power supply A. However, the method of detecting the coil current IL is not limited to the above.

The duty signal generation circuit 30 receives the error signal EOUT and the current detection signals ISNS to generate a duty signal PWM. Referring to this figure, the duty signal generation circuit 30 includes an output feedback amplifier 31 and a comparator 32.

The output feedback amplifier 31 receives the error signal EOUT and the current detection signals ISNS to generate a control voltage VC according to the received signals. For example, a first non-inverting input terminal (+) of the output feedback amplifier 31 is connected to a terminal for applying the error signal EOUT. A first inverting input terminal (−) of the output feedback amplifier 31 is connected to a terminal for applying a bias voltage EOUT_REF. A second non-inverting input terminal (+) of the output feedback amplifier 31 is connected to a terminal for applying the negative-phase current detection signal ISNSN. A second inverting input terminal (−) of the output feedback amplifier 31 is connected to a terminal for applying the positive-phase current detection signal ISNSP.

The output feedback amplifier 31 connected in this manner generates a control voltage VC so that a difference value (EOUT−EOUT_REF) between the error signal EOUT and the bias voltage EOUT_REF matches a difference value (ISNSP−ISNSN) between the positive-phase current detection signal ISNSP and the negative-phase current detection signal ISNSN.

The comparator 32 generates a duty signal PWM by comparing the control voltage VC with a ramp voltage VR. The ramp voltage VR may be, for example, a triangular wave, a sawtooth wave, or an n-th order slope wave (e.g., n=2) that rises during an on-period Ton of the transistor MH.

The duty signal PWM is at a high level when the ramp voltage VR is lower than the control voltage VC, and is at a low level when the ramp voltage VR is higher than the control voltage VC. The duty signal PWM may be understood as a signal for determining an off-timing of the transistor MH. An on-duty D (=Ton/Tsw) of the duty signal PWM, i.e., a ratio of the on-period Ton to the switching period Tsw, increases as the control voltage VC increases, and decreases as the control voltage VC decreases.

As described above, in the switching power supply A according to the present disclosure, output feedback control is executed so that the difference value (EOUT−EOUT_REF) between the error signal EOUT and the bias voltage EOUT_REF coincides with the difference value (ISNSP−ISNSN) between the positive-phase current detection signal ISNSP and the negative-phase current detection signal ISNSN. As a result, the coil current IL is controlled according to the difference value (EOUT−EOUT_REF) between the error signal EOUT and the bias voltage EOUT_REF.

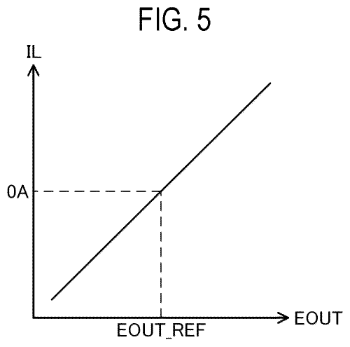

FIG. 5 is a diagram showing a relationship between the error signal EOUT and the coil current IL, where the horizontal axis represents the error signal EOUT and the vertical axis represents the coil current IL.

When the error signal EOUT is higher than the bias voltage EOUT_REF, as the absolute value of the error signal EOUT increases, the coil current IL flowing in a positive direction (=from the output circuit 2 to the load) increases. On the other hand, when the error signal EOUT is lower than the bias voltage EOUT_REF, as the absolute value of the error signal EOUT increases, the coil current IL flowing in the negative direction (=from the load to the output circuit 2) increases. When the error signal EOUT and the bias voltage EOUT_REF are equal to each other, the coil current IL becomes 0 A. In other words, the error signal EOUT matches the bias voltage EOUT_REF when the coil current IL is 0 A.

As described above, the switching power supply A according to the present disclosure may achieve current mode control, which has better load response characteristics than the voltage mode control.

Returning to FIG. 4, the description of the power supply controller 1 is continued. The output feedback circuit 50 includes resistors 51 and 52 connected in series between a terminal for applying the output voltage VOUT and a ground terminal. The output feedback circuit 50 outputs a feedback voltage FB (=a divided voltage of the output voltage VOUT) according to the output voltage VOUT from a connection node between the resistors 51 and 52. However, if the output voltage VOUT falls within an input dynamic range of the error amplifier 10, the output feedback circuit 50 may be omitted and the output voltage VOUT may be directly input to the error amplifier 10.

The error amplifier 10 is switched between a first mode and a second mode in response to a mode switching signal MODE. The mode switching signal MODE may be set, for example, by an external input to a dedicated terminal, serial communication, or writing to a memory or a register.

In the first mode, the error amplifier 10 generates an error signal EOUT using an integral voltage Vcal obtained by integrating a difference value (REF-FB) calculated by subtracting the reference voltage REF from the feedback voltage FB. In the first mode, output feedback control is executed such that the output voltage VOUT coincides with a target value VOUT_target regardless of the load current Iload. That is, the first mode may be understood as a mode in which the load line function is disabled.

On the other hand, in the second mode, the error amplifier 10 generates the error signal EOUT without using the integral voltage Vcal. In the second mode, output feedback control is executed such that the output voltage VOUT is shifted according to the load current Iload. That is, the second mode may be understood as a mode in which the load line function is enabled.

As described above, in the switching power supply A according to the present disclosure, the load line function is enabled/disabled depending on whether or not the integral voltage Vcal generated inside the error amplifier 10 is used when generating the error signal EOUT. Therefore, it becomes easy to arbitrarily enable/disable the load line function while most of the control circuits forming the output feedback system are kept common.

### Error Amplifier (First Embodiment)

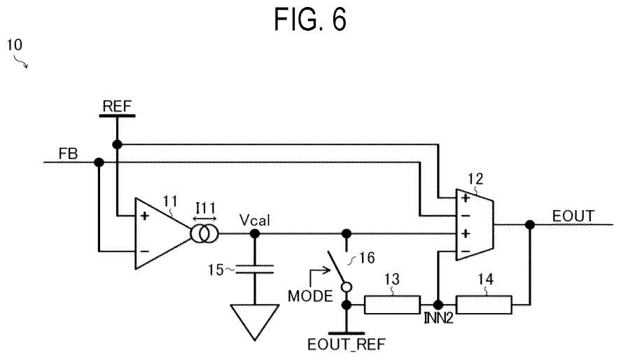

FIG. 6 is a diagram showing an error amplifier 10 according to a first embodiment of the present disclosure. The error amplifier 10 of this embodiment includes amplifiers 11 and 12, resistors 13 and 14, a capacitor 15, and a switch 16.

A non-inverting input terminal (+) of the amplifier 11 is connected to a terminal for applying the reference voltage REF. An inverting input terminal (−) of the amplifier 11 is connected to a terminal for applying the feedback voltage FB. An output terminal of the amplifier 11 is connected to a terminal for applying the integral voltage Vcal. The amplifier 11 may be a transconductance amplifier, a so-called gm amplifier, that generates a current signal I11 according to a difference value (REF-FB) between the reference voltage REF and the feedback voltage FB.

A first non-inverting input terminal (+) of the amplifier 12 is connected to the terminal for applying the reference voltage REF. A first inverting input terminal (−) of the amplifier 12 is connected to the terminal for applying the feedback voltage FB. A second non-inverting input terminal (+) of the amplifier 12 is connected to the terminal for applying the integral voltage Vcal. A second inverting input terminal (−) of the amplifier 12 is connected to a terminal for applying a node voltage INN2. An output terminal of the amplifier 12 is connected to the terminal for applying the error signal EOUT. The resistor 13 is connected between a terminal for applying the bias voltage EOUT_REF and the terminal for applying the node voltage INN2. The resistor 14 is connected between the terminal for applying the node voltage INN2 and the terminal for applying the error signal EOUT.

The amplifier 12 and the resistors 13 and 14 connected in this manner generate an error signal EOUT such that the difference value (REF-FB) between the reference voltage REF and the feedback voltage FB coincides with a difference value (Vcal-INN2) between the integral voltage Vcal and the node voltage INN2. In other words, the amplifier 12 and the resistors 13 and 14 may be understood as a circuit that adds the difference value (REF-FB) between the reference voltage REF and the feedback voltage FB and a difference value (Vcal-EOUT_REF) between the integral voltage Vcal and the bias voltage EOUT_REF, and amplifies the sum by a constant factor.

The capacitor 15 is connected between the terminal for applying the integral voltage Vcal and a reference potential terminal. The capacitor 15 is charged and discharged by a current signal output from the amplifier 11. A charging voltage of the capacitor 15 is extracted as the integral voltage Vcal. The amplifier 11 and the capacitor 15 connected in this manner may be understood as a circuit that amplifies and integrates the difference value (REF-FB) between the reference voltage REF and the feedback voltage FB. The capacitor 15 may be connected between the terminal for applying the integral voltage Vcal and the terminal for applying the bias voltage EOUT_REF. That is, the capacitor 15 may be connected across the switch 16.

The switch 16 is connected between the terminal for applying the integral voltage Vcal and the terminal for applying the bias voltage EOUT_REF. The switch 16 is turned on and off in response to the mode switching signal MODE. When the error amplifier 10 is in the first mode, the switch 16 is turned off. At this time, the integral voltage Vcal is input to the amplifier 12 without being fixed by the bias voltage EOUT_REF. Therefore, the error signal EOUT is generated using the integral voltage Vcal. On the other hand, when the error amplifier 10 is in the second mode, the switch 16 is turned on. At this time, the integral voltage Vcal is fixed by the bias voltage EOUT_REF. Therefore, the error signal EOUT is generated without using the integral voltage Vcal.

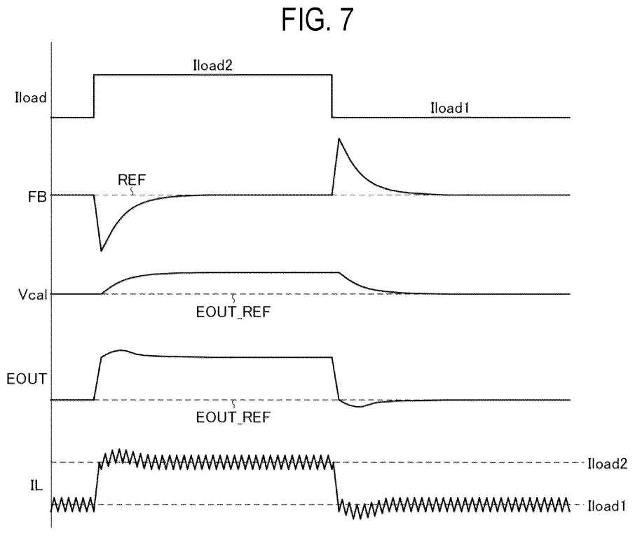

FIG. 7 is a diagram showing a load response waveform when the error amplifier 10 of the first embodiment is in the first mode, i.e., when the load line function is disabled. In this figure, the load current Iload, the feedback voltage FB, the integral voltage Vcal, the error signal EOUT, and the coil current IL are depicted sequentially from the top.

When the switch 16 is in an off state, the following formula (1) holds. In formula (1), R13 and R14 are resistance values of the resistors 13 and 14, respectively.

$$\begin{matrix}[ Formula ( 1 ) ] & \\ EOUT - EOUT\_REF = \frac{R 13 + R 14}{R 13} \times ( REF - FB + Vcal - EOUT\_REF ) & ( 1 )\end{matrix}$$

In an initial state, Iload=Iload1, FB=REF, and Vcal=EOUT_REF. In such an initial state, EOUT−EOUT_REF=0 according to formula (1).

A case is considered where the load current Iload suddenly increases from the above initial state to a set value Iload2 (>Iload1) and the feedback voltage FB drops. In this case, the integral voltage Vcal does not immediately follow the feedback voltage FB. Therefore, Vcal is maintained at EOUT_REF. Accordingly, the following formula (2) holds.

$$\begin{matrix}[ Formula ( 2 ) ] & \\ EOUT - EOUT\_REF = \frac{R 13 + R 14}{R 13} \times ( REF - FB ) & ( 2 )\end{matrix}$$

As a result, the difference value (EOUT−EOUT_REF) between the error signal EOUT and the bias voltage EOUT_REF becomes a voltage obtained by multiplying the difference value (REF−FB) between the reference voltage REF and the feedback voltage FB by a constant.

The coil current IL is increased according to the difference (EOUT−EOUT_REF) between the error signal EOUT and the bias voltage EOUT_REF. When the coil current IL reaches the load current Iload (=Iload2), the decrease in the output voltage VOUT stops.

As the time passes, the integral voltage Vcal gradually increases. The error signal EOUT increases following the integral voltage Vcal. When the coil current IL becomes larger than the load current Iload (=Iload2), the output voltage VOUT and hence the feedback voltage FB increase.

Thereafter, when FB converges to REF, the increase in the integral voltage Vcal stops. At this time, REF=FB, and the following formula (3) holds.

$$\begin{matrix}[ Formula ( 3 ) ] & \\ EOUT - EOUT\_REF = \frac{R 13 + R 14}{R 13} \times ( Vcal - EOUT\_REF ) & ( 3 )\end{matrix}$$

Then, the coil current IL and the load current Iload (=Iload2) are balanced when they are equal to each other. As seen from formula (3), the difference value (EOUT−EOUT_REF) between the error signal EOUT and the bias voltage EOUT_REF does not depend on the feedback voltage FB. In other words, the coil current IL (≈load current Iload) does not depend on the output voltage VOUT.

The case where the load current Iload suddenly decreases to the set value Iload1 from this state such that the feedback voltage FB increases may also be understood in a similar manner to the above.

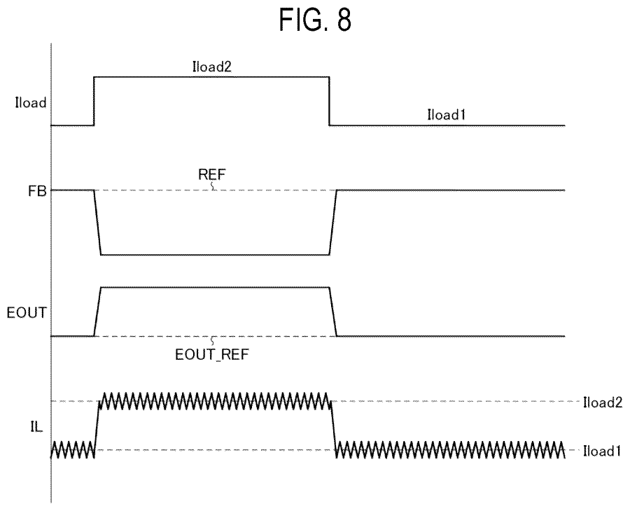

FIG. 8 is a diagram showing a load response waveform when the error amplifier 10 of the first embodiment is in the second mode, i.e., when the load line function is enabled. In this figure, the load current Iload, the feedback voltage FB, the integral voltage Vcal, the error signal EOUT, and the coil current IL are depicted sequentially from the top, as in FIG. 7 referred to above.

When the switch 16 is in an on state, Vcal=EOUT_REF. Therefore, the above-mentioned formula (2) holds. That is, the difference value (EOUT−EOUT_REF) between the error signal EOUT and the bias voltage EOUT_REF is always a voltage obtained by multiplying the difference value (REF−FB) between the reference voltage REF and the feedback voltage FB by a constant.

Therefore, when Iload=Iload1, it becomes FB=REF, and the output voltage VOUT coincides with the target value VOUT_target. Also, when Iload=Iload2, the feedback voltage FB is balanced and stabilized at a voltage value lower than the reference voltage REF. The load line function is realized by the output feedback operation described above.

As described above, with the error amplifier 10 of the first embodiment, it is possible to arbitrarily switch between the enabled and disabled states of the load line function by controlling the on/off operation of the switch 16. In addition, by changing a resistance ratio of the resistors 13 and 14, it is possible to adjust a gain of the error amplifier 10 that receives the input of the feedback voltage FB and generates the error signal EOUT, i.e., a relationship between an amount of decrease in the feedback voltage FB and an amount of increase in the coil current IL. As a result, it is possible to arbitrarily adjust the load response characteristics and the load line characteristics of the switching power supply A.

### Error Amplifier (Second Embodiment)

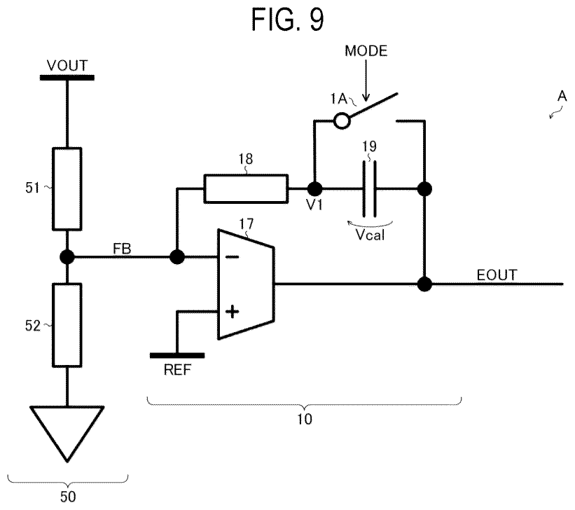

FIG. 9 is a diagram showing an error amplifier 10 according to a second embodiment of the present disclosure. The error amplifier 10 of this embodiment includes an amplifier 17, a resistor 18, a capacitor 19, and a switch 1A.

A non-inverting input terminal (+) of the amplifier 17 is connected to the terminal for applying the reference voltage REF. An inverting input terminal (−) of the amplifier 17 is connected to the terminal for applying the feedback voltage FB. An output terminal of the amplifier 17 is connected to the terminal for applying the error signal EOUT. The resistor 18 is connected between the terminal for applying the feedback voltage FB and a terminal for applying the node voltage V1. The capacitor 19 is connected between the terminal for applying the node voltage V1 and the terminal for applying the error signal EOUT. A charging voltage of the capacitor 19 may be understood as the above-mentioned integral voltage Vcal. In this way, the error amplifier 10 of this embodiment employs a configuration called Miller compensation.

The switch 1A is connected between the terminal for applying the node voltage V1 and the terminal for applying the error signal EOUT. The switch 1A is turned on and off in response to the mode switching signal MODE. When the error amplifier 10 is in the first mode, the switch 1A is turned off. At this time, both ends of the capacitor 19 are opened. Therefore, the error signal EOUT is generated using the integral voltage Vcal. On the other hand, when the error amplifier 10 is in the second mode, the switch 1A is turned on. At this time, both ends of the capacitor 19 are short-circuited. Therefore, the error signal EOUT is generated without using the integral voltage Vcal.

The capacitor 19 and the switch 1A may be connected in parallel between the terminal for applying the error signal EOUT and a reference potential terminal.

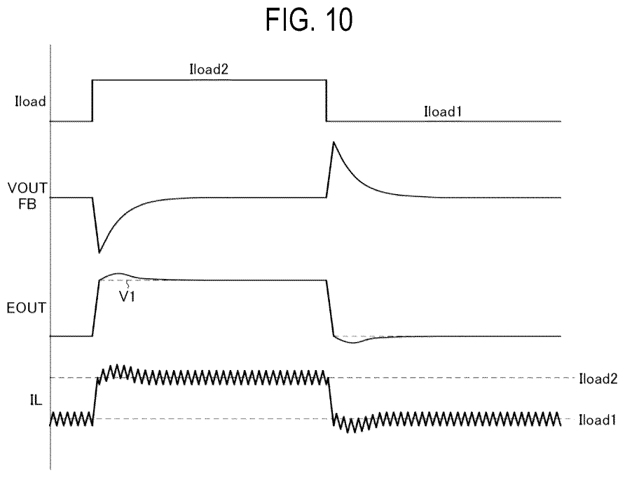

FIG. 10 is a diagram showing a load response waveform when the error amplifier 10 of the second embodiment is in the first mode, i.e., when the load line function is disabled. In this figure, the load current Iload, the output voltage VOUT (which may be understood as the feedback voltage FB), the error signal EOUT, and the coil current IL are depicted sequentially from the top.

As described above, when the error amplifier 10 is in the first mode, a component obtained by integrating the difference value (REF-FB) between the reference voltage REF and the feedback voltage FB is added to the error signal EOUT. Therefore, when the load current Iload increases, the output voltage VOUT drops temporarily, but returns to the target value VOUT_target over time. The same holds true when the load current Iload decreases, where the output voltage VOUT rises temporarily and then converges to the target value VOUT_target.

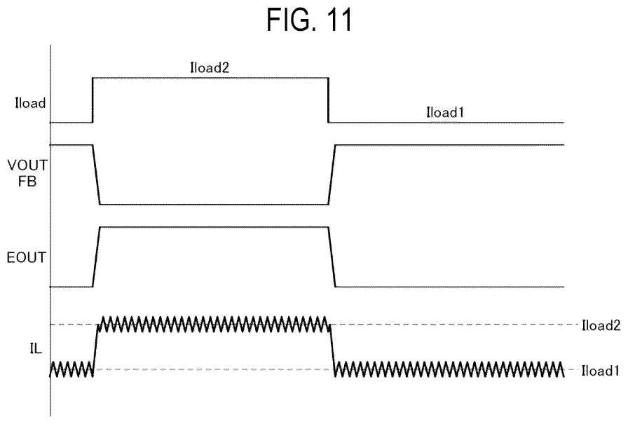

FIG. 11 is a diagram showing a load response waveform when the error amplifier 10 of the second embodiment is in the second mode, i.e., when the load line function is enabled. In this figure, as in FIG. 10 referred to above, the load current Iload, the output voltage VOUT (which may be understood as the feedback voltage FB), the error signal EOUT, and the coil current IL are depicted sequentially from the top.

When the switch 1A is in the on state, the following formula (4) holds.

$$\begin{matrix}[ Formula ( 4 ) ] & \\ EOUT - REF = \frac{R 18}{R 51} \times ( VOUT\_target - VOUT ) & ( 4 )\end{matrix}$$

That is, the error signal EOUT is a voltage obtained by multiplying a difference value (VOUT_target−VOUT) between the output voltage VOUT and the target value VOUT_target by a constant.

Unlike the above-mentioned formula (2), the left side of formula (4) is EOUT−REF. Therefore, when the error amplifier 10 of the second embodiment is adopted, it is preferable to set EOUT_REF=REF in the power supply controller 1 of FIG. 4. According to such setting, as shown in this figure, output feedback control is executed such that the output voltage VOUT is shifted according to the load current Iload. In other words, the load line function is enabled.

As described above, with the error amplifier 10 of the second embodiment, it is possible to arbitrarily switch between the enabled and disabled states of the load line function by controlling the on/off operation of the switch 1A.

### <Soft Start Function>

The power supply controller 1 has a function of gradually increasing the output voltage VOUT at the startup, which is a so-called soft start function. For example, the soft start function may be realized by gradually increasing the reference voltage REF from 0 V to a predetermined value by applying an appropriate soft start time Tss at the startup of the power supply controller 1.

However, as described above, when the error amplifier 10 of the second embodiment is adopted, it is necessary to set EOUT_REF=REF. Therefore, it is necessary to pay attention to compatibility with the soft start function.

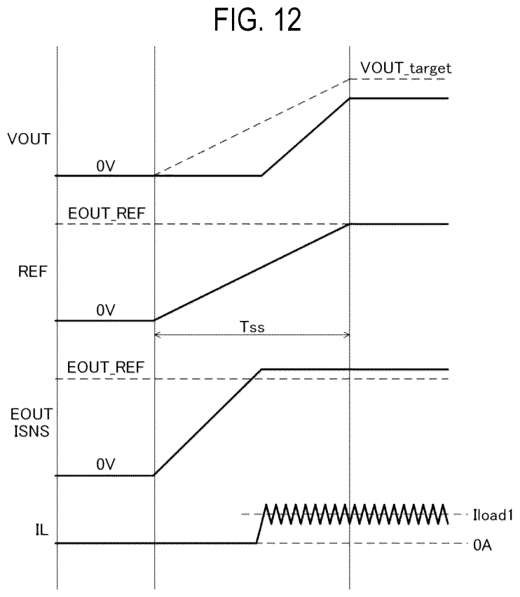

FIG. 12 is a diagram showing a first example of the soft start function in the power supply controller 1. In this figure, the output voltage VOUT, the reference voltage REF, the error signal EOUT (which may be understood as the current detection signal ISNS), and the coil current IL are depicted sequentially from the top.

This figure illustrates the behavior when the reference voltage REF is gradually increased from 0 V over the soft start time Tss at the startup of the power supply controller 1, and when EOUT_REF=REF after the startup of the power supply controller 1 is completed.

In this case, it takes a relatively long time for the error signal EOUT to exceed the bias voltage EOUT_REF. Referring to this figure, at a point of time where REF=0.5×EOUT_REF, the positive coil current IL finally starts to flow and the output voltage VOUT starts to rise. Furthermore, when EOUT<EOUT_REF, the coil current IL may flow in the negative direction. Therefore, the power supply controller 1 needs to take measures such as waiting to drive the output circuit 2 until EOUT≥EOUT_REF.

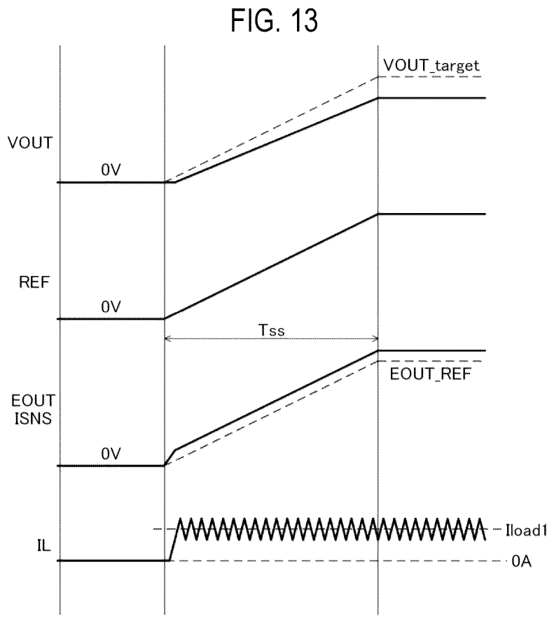

FIG. 13 is a diagram showing a second example of the soft start function in the power supply controller 1. In this figure, as in FIG. 12, the output voltage VOUT, the reference voltage REF, the error signal EOUT (which may be understood as the current detection signal ISNS), and the coil current IL are depicted sequentially from the top.

This figure illustrates the behavior when both the reference voltage REF and the bias voltage EOUT_REF are gradually increased from 0 V to a predetermined value over the soft start time Tss at the startup of the power supply controller 1. In this case, as the reference voltage REF increases, the output voltage VOUT also begins to increase without delay. Therefore, in principle, an ideal startup operation is realized. However, it should be noted that the error signal EOUT generated by the error amplifier 10 is not necessarily easy to start up from 0 V.

### <Switching Power Supply (Modification)>

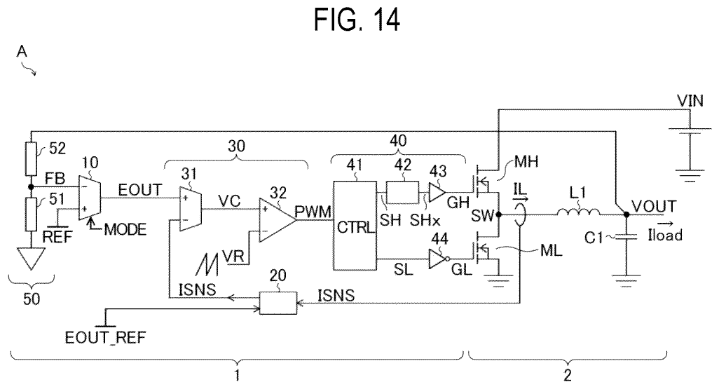

FIG. 14 is a diagram showing a modification of the switching power supply A according to the present disclosure. The switching power supply A of this modification is based on FIG. 4 referred to above, but the current sensor 20 is changed to a single-phase output. In addition, due to this change, the output feedback amplifier 31 of the duty signal generation circuit 30 is also changed.

The current sensor 20 outputs a single-phase current detection signal ISNS using the bias voltage EOUT_REF as a reference value. For example, when the coil current IL flows in the positive direction, ISNS>EOUT_REF. On the other hand, when the coil current IL flows in the negative direction, ISNS<EOUT_REF.

The output feedback amplifier 31 generates a control voltage VC so that the error signal EOUT input to a non-inverting input terminal (+) coincides with the current detection signal ISNS input to an inverting input terminal (−). In this way, the output feedback amplifier 31 is changed from a four-input type to a two-input type, unlike the output feedback amplifier 31 shown in FIG. 4 referred to above.

Even when this modification is adopted, the relationship between the error signal EOUT and the coil current IL is the same as that described above (see FIG. 5). Therefore, by using the error amplifier 10 of the first embodiment (FIG. 6) or the second embodiment (FIG. 9), the load line function may be easily switched between the enabled and disabled states in response to the mode switching signal MODE.

### Supplementary Note

In the switching power supply disclosed herein, it is possible to arbitrarily switch between the enabled and disabled states of the function of changing the output voltage according to the load current, the so-called load line function. The following supplementary notes are provided regarding the above-described disclosure.

### Supplementary Note 1

A power supply controller (1) configured to control an output circuit (2) of a switching power supply (A) that generates an output voltage (VOUT) from an input voltage (VIN), including:
an error amplifier (10) configured to generate an error signal (EOUT) according to an error between a feedback voltage (FB) corresponding to the output voltage (VOUT) and a predetermined reference voltage (REF);
a current sensor (20) configured to generate a current detection signal (ISNS) according to a coil current (IL) flowing through the output circuit (2);
a duty signal generation circuit (30) configured to generate a duty signal (PWM) upon receiving the error signal (EOUT) and the current detection signal (ISNS); and
a drive signal generation circuit (40) configured to generate a drive signal (GH and/or GL) for the output circuit (2) upon receiving the duty signal (PWM),
wherein the error amplifier (10) is configured to be capable of being switched between a first mode and a second mode in response to a mode switching signal (MODE), and is configured to, in the first mode, generate the error signal (EOUT) using an integral voltage (Vcal) obtained by integrating a difference value (REF-FB) obtained by subtracting the reference voltage (REF) from the feedback voltage (FB), and in the second mode, generate the error signal (EOUT) without using the integral voltage (Vcal).

### Supplementary Note 2

The power supply controller (1) of Supplementary Note 1, wherein the duty signal generation circuit (30) includes an output feedback amplifier (31) configured to receive the error signal (EOUT) and the current detection signal (ISNS) to generate a control voltage (VC) according to the error signal (EOUT) and the current detection signal (ISNS), and a comparator (32) configured to compare the control voltage (VC) with a ramp voltage (VR) to generate the duty signal (PWM).

### Supplementary Note 3

The power supply controller (1) of Supplementary Note 1 or 2, wherein the error amplifier (10) includes:
a first amplifier (11) including a non-inverting input terminal (+) connected to a terminal for applying the reference voltage (REF), an inverting input terminal (−) connected to a terminal for applying the feedback voltage (FB), and an output terminal connected to a terminal for applying the integral voltage (Vcal);
a second amplifier (12) including a first non-inverting input terminal (+) connected to the terminal for applying the reference voltage (REF), a first inverting input terminal (−) connected to the terminal for applying the feedback voltage (FB), a second non-inverting input terminal (+) connected to the terminal for applying the integral voltage (Vcal), a second inverting input terminal (−) connected to a terminal for applying a node voltage (INN2), and an output terminal connected to a terminal for applying the error signal (EOUT);
a first resistor (13) connected between a terminal for applying a bias voltage (EOUT_REF) and the terminal for applying the node voltage (INN2);
a second resistor (14) connected between the terminal for applying the node voltage (INN2) and the terminal for applying the error signal (EOUT);
a capacitor (15) connected between the terminal for applying the integral voltage (Vcal) and a reference potential terminal or between the terminal for applying the integral voltage (Vcal) and the terminal for applying the bias voltage; and
a switch (16) connected between the terminal for applying the integral voltage (Vcal) and the terminal for applying the bias voltage (EOUT_REF) and configured to be turned on and off in response to the mode switching signal (MODE).

### Supplementary Note 4

The power supply controller (1) of Supplementary Note 3, wherein the error signal (EOUT) coincides with the bias voltage (EOUT_REF) when the coil current (IL) is zero.

### Supplementary Note 5

The power supply controller (1) of Supplementary Note 1 or 2, wherein the error amplifier (10) includes:
an amplifier (17) including a non-inverting input terminal (+) connected to a terminal for applying the reference voltage (REF), an inverting input terminal (−) connected to a terminal for applying the feedback voltage (FB), and an output terminal connected to a terminal for applying the error signal (EOUT);
a resistor (18) connected between the terminal for applying the feedback voltage (FB) and a terminal for applying a node voltage (V1);
a capacitor (19) connected between the terminal for applying the node voltage (V1) and the terminal for applying the error signal (EOUT); and
a switch (1A) connected between the terminal for applying the node voltage (V1) and the terminal for applying the error signal (EOUT) and configured to be turned on and off in response to the mode switching signal (MODE).

### Supplementary Note 6

The power supply controller (1) of Supplementary Note 3 or 4, wherein the reference voltage (REF) and the bias voltage (EOUT_REF) rise to a predetermined value over a soft start time (Tss) during startup of the power supply controller (1).

### Supplementary Note 7

The power supply controller (1) of any one of Supplementary Notes 3, 4 and 6, wherein the current sensor (20) is configured to differentially output a positive-phase current detection signal (ISNSP) and a negative-phase current detection signal (ISNSN) as the current detection signal (ISNS), and
wherein the output feedback amplifier (31) is configured to generate the control voltage (VC) so that a difference value (EOUT−EOUT_REF) between the error signal (EOUT) and the bias voltage (EOUT_REF) coincides with a difference value (ISNSP−ISNSN) between the positive-phase current detection signal (ISNSP) and the negative-phase current detection signal (ISNSN).

### Supplementary Note 8

The power supply controller (1) of any one of Supplementary Notes 3, 4 and 6, wherein the current sensor (20) is configured to output the current detection signal (ISNS) in a single phase using the bias voltage (EOUT_REF) as a reference value, and
wherein the output feedback amplifier (31) is configured to generate the control voltage (VC) so that the error signal (EOUT) coincides with the current detection signal (ISNS).

### Supplementary Note 9

The power supply controller (1) of any one of Supplementary Notes 1 to 8, wherein the mode switching signal (MODE) is set by external input to a dedicated terminal, serial communication, or writing to a memory or a register.

### Supplementary Note 10

A switching power supply (A), including:
the power supply controller (1) of any one of Supplementary Notes 1 to 9; and
the output circuit (2).

### Others

In addition to the above-described embodiments, the various technical features disclosed in this specification may be modified in various ways without departing from the spirit of the technical creation. In other words, the above-described embodiments should be considered to be exemplary and not limitative in all respects. Furthermore, the technical scope of the present disclosure is defined by the claims, and should be understood to include all modifications that are equivalent in meaning and scope to the claims.

While certain embodiments have been described, these embodiments have been presented by way of example only, and are not intended to limit the scope of the disclosures. Indeed, the embodiments described herein may be embodied in a variety of other forms. Furthermore, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A power supply controller configured to control an output circuit of a switching power supply that generates an output voltage from an input voltage, comprising:
an error amplifier configured to generate an error signal according to an error between a feedback voltage corresponding to the output voltage and a predetermined reference voltage;
a current sensor configured to generate a current detection signal according to a coil current flowing through the output circuit;
a duty signal generation circuit configured to generate a duty signal upon receiving the error signal and the current detection signal; and
a drive signal generation circuit configured to generate a drive signal for the output circuit upon receiving the duty signal,
wherein the error amplifier is configured to be capable of being switched between a first mode and a second mode in response to a mode switching signal, and is configured to, in the first mode, generate the error signal using an integral voltage obtained by integrating a difference value obtained by subtracting the reference voltage from the feedback voltage, and in the second mode, generate the error signal without using the integral voltage.

2. The power supply controller of claim 1, wherein the duty signal generation circuit includes an output feedback amplifier configured to receive the error signal and the current detection signal to generate a control voltage according to the error signal and the current detection signal, and a comparator configured to compare the control voltage with a ramp voltage to generate the duty signal.

3. The power supply controller of claim 2, wherein the error amplifier includes:
a first amplifier including a non-inverting input terminal connected to a terminal for applying the reference voltage, an inverting input terminal connected to a terminal for applying the feedback voltage, and an output terminal connected to a terminal for applying the integral voltage;
a second amplifier including a first non-inverting input terminal connected to the terminal for applying the reference voltage, a first inverting input terminal connected to the terminal for applying the feedback voltage, a second non-inverting input terminal connected to the terminal for applying the integral voltage, a second inverting input terminal connected to a terminal for applying a node voltage, and an output terminal connected to a terminal for applying the error signal;
a first resistor connected between a terminal for applying a bias voltage and the terminal for applying the node voltage;
a second resistor connected between the terminal for applying the node voltage and the terminal for applying the error signal;
a capacitor connected between the terminal for applying the integral voltage and a reference potential terminal or between the terminal for applying the integral voltage and the terminal for applying the bias voltage; and
a switch connected between the terminal for applying the integral voltage and the terminal for applying the bias voltage and configured to be turned on and off in response to the mode switching signal.

4. The power supply controller of claim 3, wherein the error signal coincides with the bias voltage when the coil current is zero.

5. The power supply controller of claim 1, wherein the error amplifier includes:
an amplifier including a non-inverting input terminal connected to a terminal for applying the reference voltage, an inverting input terminal connected to a terminal for applying the feedback voltage, and an output terminal connected to a terminal for applying the error signal;
a resistor connected between the terminal for applying the feedback voltage and a terminal for applying a node voltage;
a capacitor connected between the terminal for applying the node voltage and the terminal for applying the error signal; and
a switch connected between the terminal for applying the node voltage and the terminal for applying the error signal and configured to be turned on and off in response to the mode switching signal.

6. The power supply controller of claim 3, wherein the reference voltage and the bias voltage rise to a predetermined value over a soft start time during startup of the power supply controller.

7. The power supply controller of claim 3, wherein the current sensor is configured to differentially output a positive-phase current detection signal and a negative-phase current detection signal as the current detection signal, and
wherein the output feedback amplifier is configured to generate the control voltage so that a difference value between the error signal and the bias voltage coincides with a difference value between the positive-phase current detection signal and the negative-phase current detection signal.

8. The power supply controller of claim 3, wherein the current sensor is configured to output the current detection signal in a single phase using the bias voltage as a reference value, and
wherein the output feedback amplifier is configured to generate the control voltage so that the error signal coincides with the current detection signal.

9. The power supply controller of claim 1, wherein the mode switching signal is set by external input to a dedicated terminal, serial communication, or writing to a memory or a register.

10. A switching power supply, comprising:
the power supply controller of claim 1; and
the output circuit.
